(19) United States
(12) Patent Application Publication
(10) Pub. No.: US 2026/0120105 A1
(43) Pub. Date: Apr. 30, 2026

(54) SELF-LEARNING APPARATUS TO DETECT POSSIBLE FINANCIAL FRAUD BEHAVIOR WITHIN A PAYMENT PROCESSOR

(71) Applicant: eBay Inc., San Jose, CA (US)

(72) Inventors: Hari Narayanan RANGARAJAN, San Jose, CA (US); Zhengqing QIU, Singapore (SG); Lingjiang XIE, Shanghai (CN)

(21) Appl. No.: 18/932,309

(22) Filed: Oct. 30, 2024

(51) Int. Cl. G06Q 20/40; G06F 9/455; G06Q 10/0633

(52) U.S. Cl. CPC G06Q 20/4016; G06F 9/455; G06Q 10/0633

(57) ABSTRACT

Some aspects of the present technology relate to technologies for providing a self-learning apparatus to detect all possible financial fraud behavior within a payment processor. In accordance with some configurations, payment protocols are modeled as a graph and a model simulation exhaustively searches all possible states spaces. Invariants are checked at each step and invariant violations (i.e., exploits) are logged with the sequence of steps that led to a respective exploit. In some aspects, upon determining a fix for the exploit, the graph model is updated and the model simulation is run again to confirm the fix has eliminated the exploit. A policy update or code enhancement may be implemented to modify the payment protocol accordingly.

### BACKGROUND

In the evolving landscape of digital finance, fraudulent manipulation of payment processors presents a multifaceted challenge, jeopardizing both financial stability and consumer trust. Such malfeasances not only culminate in financial losses but also imperil the operational integrity of payment processors, risking regulatory non-compliance and potential revocation of licensing.

### SUMMARY

Some aspects of the present technology relate to, among other things, a self-learning apparatus to detect possible financial fraud behavior within a payment processor. In accordance with some configurations, payment protocols are modeled as a graph and a model simulation exhaustively searches all possible states spaces. Invariants are checked at each step and invariant violations (i.e., exploits) are logged with the sequence of steps that led to a respective exploit. In some aspects, upon determining a fix for the exploit, the graph model is updated and the model simulation is run again to confirm the fix has eliminated the exploit. A policy update or code enhancement may be implemented to modify the payment protocol accordingly.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system, in accordance with some implementations of the present disclosure;

FIG. 2 is an example of a network architecture of an exploit remediation system, in accordance with some implementations of the present disclosure;

FIG. 3 is a diagram of an example of mathematics-based modeling of a transaction, in accordance with some implementations of the present disclosure;

FIG. 4 depicts an example of complex transactional relationships and patterns within financial data, in accordance with some implementations of the present disclosure;

FIG. 5 depicts an example of a collection of data as journal information of daily transactions per transaction type, in accordance with some implementations of the present disclosure;

FIG. 6 is a diagram of a various patterns of a particular transaction, including a quantity of each pattern, in accordance with some implementations of the present disclosure;

FIG. 7 is a flow diagram showing a method for detecting and eliminating possible financial fraud behavior within a payment processor, in accordance with some implementations of the present disclosure; and

FIG. 8 is a block diagram of an exemplary computing environment suitable for use in implementations of the present disclosure.

### DETAILED DESCRIPTION

Secure and accurate payment protocols (process flows that involve money and modeled as a protocol with an allowed sequence of actions) are crucial to digital finance systems. Fraudsters are constantly finding new methods to exploit weaknesses or gaps and manipulate the flow of money to enrich themselves or others.

Malicious users continuously attempt different sequences of various actions in attempts to find exploits within the systems. A payment exploit is identified when a particular action sequences allows a malicious user to manipulate a system owner into depositing funds that results in a net negative loss. For example, malicious sellers may be able to convert bad funds (e.g., from stolen cards or bank accounts) into good funds (e.g., credits or refunds within the system) through fee exploitation. This enables a malicious seller to withdraw the funds, resulting in a loss for the system owner as the bad funds never settle or result in a chargeback.

By way of example, a seller may list an item with a low average sale price for sale with an inflated shipping fee. In this example, the item may be a delayed listing (i.e., it may not be visible in the marketplace or catalog); however, the buyer is able to access the listing (e.g., the seller sends the item directly to the buyer offline). Next, the buyer selects cash on pickup as the payment method. In other words, there is collusion between the seller and the buyer. A final value fee is charged and the seller available balance (SVP) goes negative equal to the amount of fees. The seller pays the negative balance (e.g., with a stolen credit card) and the SVA is $0. If the seller cancels the transaction, the fees are returned to the SVA rather than refunding the OTP to the original funding instrument. As a result, the SVA is positive and the seller is eligible for a payout. Since the restriction/payout block happens a day or two later, the on-demand payout (and the fraud) is completed.

In another example, a transaction with a high advertisement fee scenario creates a fraudulent activity. For example, the seller may be charged a high advertisement fee and initiates a refund of a transaction and the fee using a credit card. A credit for the advertisement fee is added to the SVA. Once the seller adds bank account information and initiates an on-demand payout, a chargeback is received on the credit card and the fraudulent activity is completed.

In yet another example, a buyer may purchase an item but does not pay (i.e., commits to buy the item). The seller marks the item as paid and is charged a final value fee. After the seller pays the final value fee using a credit card, the seller initiates a cancellation of the transaction. The final value fee is refunded to the SVA. The seller adds bank account information and initiates an on-demand payout. A chargeback is eventually received on the credit card and the fraudulent activity is completed.

Conventional methods to address these weaknesses or gaps suffer from two primary issues. Payment protocol analysis is performed by hand and prone to errors. Moreover, actual implementation in the code may not match the theoretical equivalent of the language used to describe it. Additionally, payment protocols continuously evolve which requires constant enumeration of the analysis to match and validate related code. Each of these manual processes is labor intensive and prone to domain-translation errors.

Aspects of the technology described herein provide an artificial intelligence-based self-learning and self-testing process flow that can be used to analyze network based protocols (e.g., a domain of payment processors that involves money flow between a provider and end-users (e.g., clients or customers). In accordance with some configurations, payment protocols are modeled as a graph and a model simulation exhaustively searches all possible states spaces. Invariants are checked at each step and invariant violations (i.e., exploits) are logged with the sequence of steps that led to a respective exploit. In some aspects, upon determining a fix for the exploit, the graph model is updated and the model simulation is run again to confirm the fix has eliminated the exploit. A policy update or code enhancement may be implemented to modify the payment protocol accordingly.

By leveraging advanced algorithms for the automatic identification of payment patterns, the present invention uncovers vulnerabilities exploitable by fraudsters. Moreover, the ability to exhaustively identify potential fraud mechanisms provides a robust framework for enhancing the security and reliability of digital payment ecosystems.

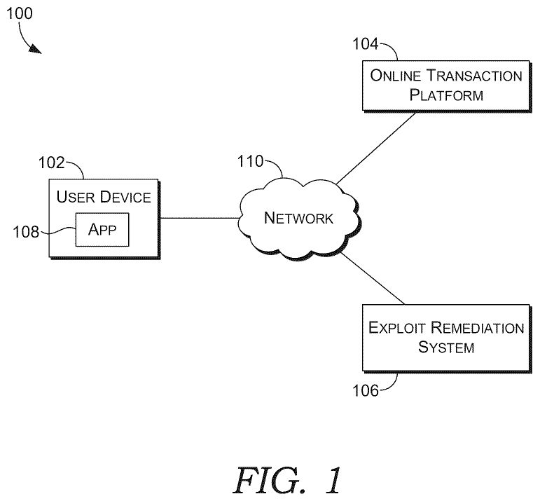

With reference now to the drawings, FIG. 1 is a block diagram illustrating an exemplary system 100 for detecting abnormal payment behavior using graph model embedding and anomaly detection, in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

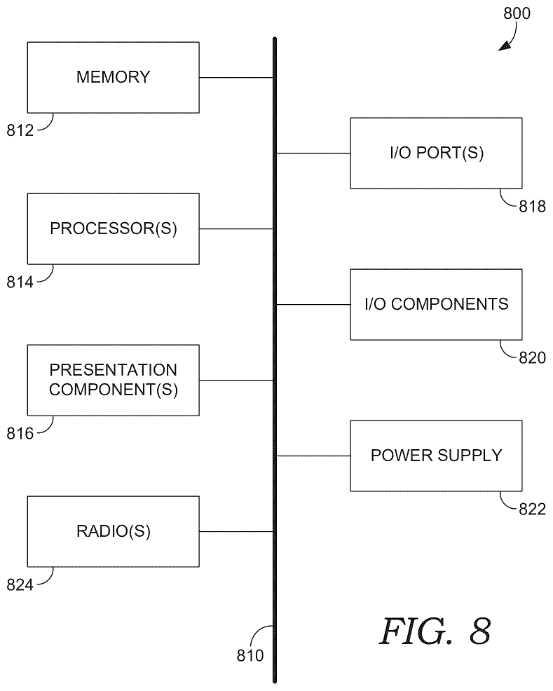

The system 100 is an example of a suitable architecture for implementing certain aspects of the present disclosure. Among other components not shown, the system 100 includes a user device 102, an online transaction platform 104, and an exploit remediation system 106. Each of the user device 102, the online transaction platform 104, and the exploit remediation system 106 shown in FIG. 1 can comprise one or more computer devices, such as the computing device 800 of FIG. 8, discussed below. As shown in FIG. 1, the user device 102, the online transaction platform 104, and the exploit remediation system 106 can communicate via a network 110, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present technology. Each may comprise a single device or multiple devices cooperating in a distributed environment. For instance, the online transaction platform 104 and the exploit remediation system 106 could each be provided by multiple server devices collectively providing the functionality of the online transaction platform 104 and the exploit remediation system 106 as described herein. Additionally, other components not shown may also be included within the network environment.

The user device 102 can be a client device on the client-side of operating environment 100, while the online transaction platform 104 and the exploit remediation system 106 can be on the server-side of operating environment 100. The online transaction platform 104 and/or the exploit remediation system 106 can each comprise server-side software designed to work in conjunction with client-side software on the user device 102 so as to implement any combination of the features and functionalities discussed in the present disclosure. For instance, the user device 102 can include an application 108 for interacting with the online transaction platform 104 and/or the exploit remediation system 106. The application 108 can be, for instance, a web browser or a dedicated application for providing functions, such as interacting with the online transaction platform 104 and/or the exploit remediation system 106. This division of operating environment 100 is provided to illustrate one example of a suitable environment, and there is no requirement for each implementation that any combination of the online transaction platform 104 and the exploit remediation system 106 remain as separate entities. For instance, in some aspects, the exploit remediation system 106 is a part of the online transaction platform 104. While the operating environment 100 illustrates a configuration in a networked environment with a separate user device, online transaction platform, and exploit remediation system, it should be understood that other configurations can be employed in which aspects of the various components are combined.

The user device 102 may comprise any type of computing device capable of use by a user. For example, in one aspect, a user device may be the type of computing device 800 described in relation to FIG. 8 herein. By way of example and not limitation, the user device 102 may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user may be associated with the user device 102 and may interact with the online transaction platform 104 and/or the exploit remediation system 106 via the user device 102.

The online transaction platform 104 can be implemented using one or more server devices, one or more platforms with corresponding application programming interfaces, cloud infrastructure, and the like. The online transaction platform 104 generally comprises any computer-based system that facilitates electronic transactions over the network 110 via user devices, such as the user device 102. In some aspects, the online transaction platform 104 comprises a listing platform (e.g., an e-commerce platform) that generally provides, to the user device 102, item listings describing items (physical or digital) available for purchase, rent, streaming, download, etc., and facilitates electronic purchase transactions for items. In other aspects, the online transaction platform 104 comprises a payment platform that facilitates electronic payment transactions between two accounts. In still further aspects, the online transaction platform 104 comprises a banking platform that facilitates the electronic transfer of money between accounts.

As described in further detail below, the exploit remediation system 106 provides a self-learning apparatus to detect possible financial fraud behavior within a payment processor, such as the user device 102, and an online transaction platform, such as the online transaction platform 104. The exploit remediation system 106 may be in addition to other components that provide further additional functions beyond the features described herein. The exploit remediation system 106 can be implemented using one or more server devices, one or more platforms with corresponding application programming interfaces, cloud infrastructure, and the like. While the exploit remediation system 106 is shown separate from the online transaction platform 104 and the user device 102 in the configuration of FIG. 1, it should be understood that in other configurations, some of the functions of the exploit remediation system 106 can be provided on the online transaction platform 104 and/or the user device.

In some aspects, the functions performed by components of the exploit remediation system 106 are associated with one or more applications, services, or routines. In particular, such applications, services, or routines may operate on one or more user devices, servers, may be distributed across one or more user devices and servers, or be implemented in the cloud. Moreover, in some aspects, these components of the exploit remediation system 106 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

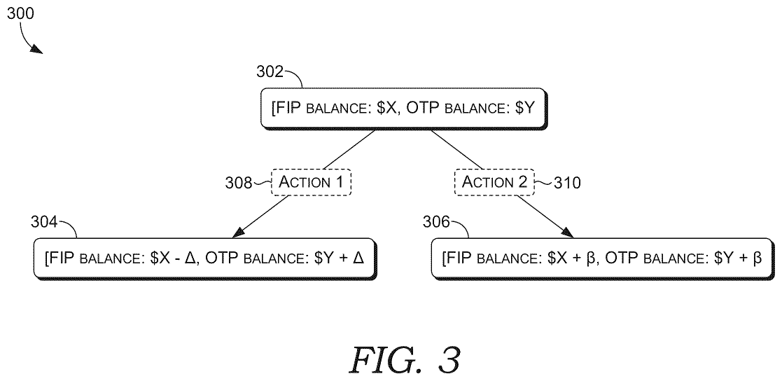

The exploit remediation system 106 generally leverages a classical mathematics-based protocol modeling methodology. Referring now to FIG. 3, an example of a complex transactional relationship and pattern within financial data 300 is illustrated, in accordance with some implementations of the present disclosure. As illustrated, the exploit remediation system the payment process is structured as a tuple comprising elements such as user transactions, payments, and financial provider interactions. For example, an initial balance 302 may be represented. Base on a first action 308 or a second action 310, the balance may change. In this example, first action 308 causes the balance to change as represented by balance 304. Or, as illustrated, second action 310 causes the balance to change as represented by balance 306. This representation allows for a systematic analysis of the payment network, facilitating the identification and resolution of potential vulnerabilities.

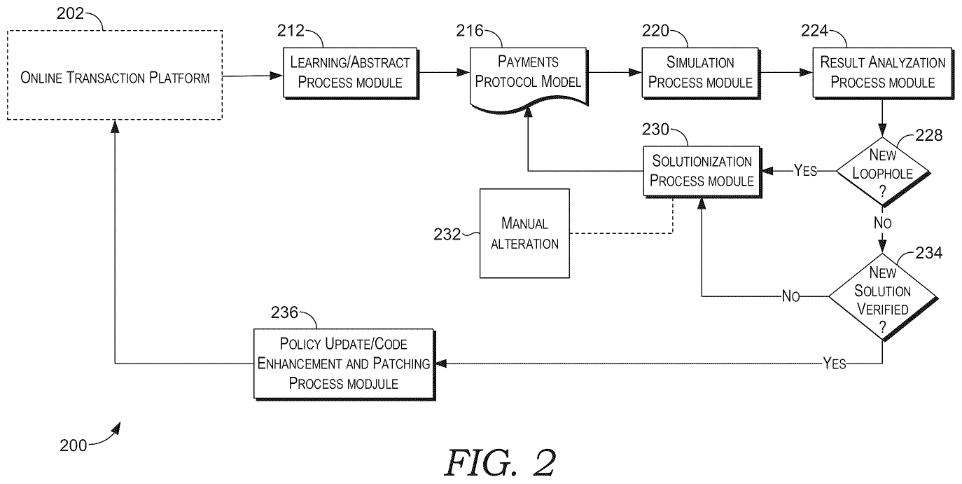

FIG. 2 depicts a diagram of an example system 200 for detecting and eliminating financial fraud behavior within a payment processor, in accordance with some implementations of the present disclosure. In some aspects, various components of the system 200 may be referred to as a graph model, a large language model, and/or a simulation engine. The online transaction platform 202 includes a collection of data including transaction data, order/item information, ledger information (e.g., a seller ledger book), and/or seller transaction data. In some aspects, the collection of data includes data systems such as a financial accounting system and/or order management system. In these systems, each transactional order generates distinct records, commonly known as journal entries. Each journal entry records a financial transaction between two distinct accounts, representing a transfer relationship. The transfer relationship inherently exhibits the characteristics of a graph structure, where accounts are represented as nodes and transactions as edges connecting these nodes.

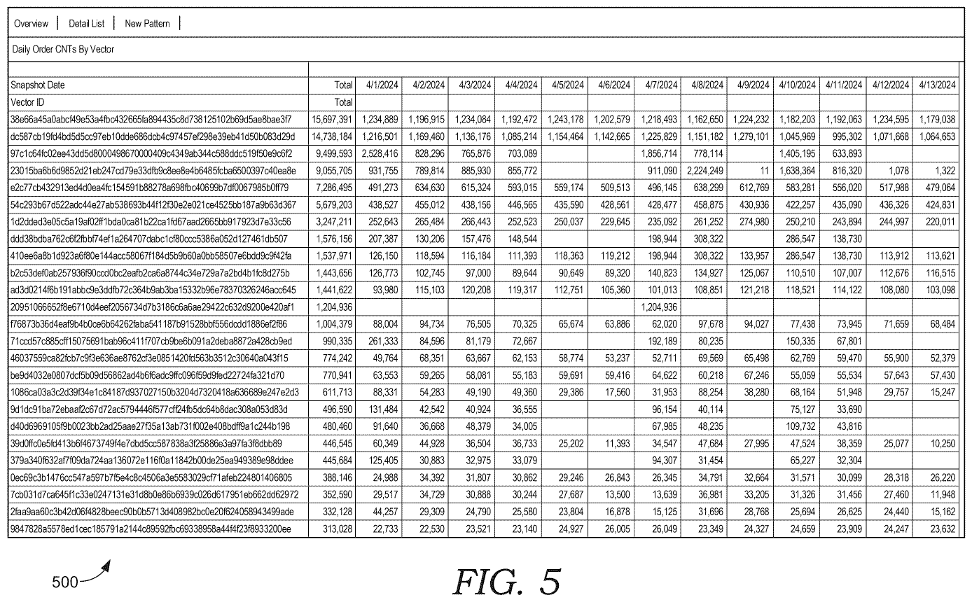

In some aspects, the online transaction platform 202 provides the collection of data as input to learning abstract process module 212. In some aspects, and referring now to FIG. 5, the online transaction platform 202 provides the collection of data as journal information 500 of daily transactions per transaction type. In some aspects, the procedure for extracting the graph pattern may be methodically delineated: a graph is constructed based on the journal information of each order, followed by an embedding process, and subsequently, the resultant vector is hashed to generate the graph pattern (the graph pattern may be referred to as or represent a particular workflow). In aspects, the graph patterns may significantly diminish the volume of data requiring analysis.

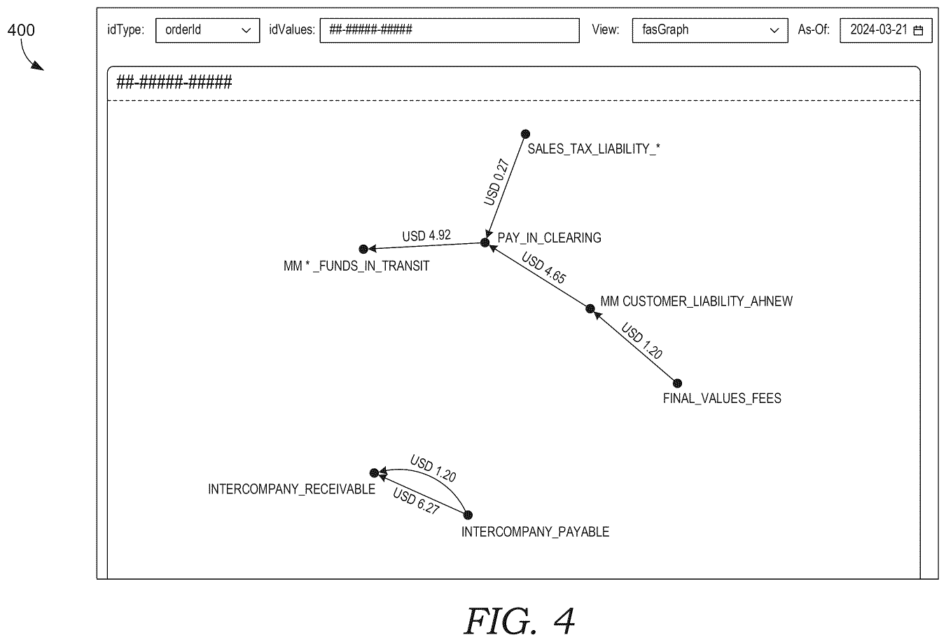

Referring now to FIG. 4, an example of complex transactional relationships and patterns within financial data is depicted, in accordance with some implementations of the present disclosure. The graphical interpretation 400 enables the simulation process module to analyze complex transactional relationships and patterns within financial data. This model quantitatively depicts the flow of transactions over time, capturing the dynamic nature of financial activities within a system. As can be appreciated, the graph pattern provides predictive insight into payment behaviors. For clarity, a graph pattern refers to the structured representation of transaction relationships within the online transaction platform 202. In some aspects, the graph patterns are refreshed daily.

Referring back to FIG. 2, the learning abstract process module 212 converts the collection of data into a graph pattern and provides the graph pattern to payments protocol module 216. In some aspects, payments protocol module utilizes a large language model to convert each transaction represented by the graph pattern into a workflow usable by simulation process module 220. In some aspects, the large language model may be a math-based language for modeling computer programs and systems (e.g., Temporal Logic of Actions, Plus (TLA+)).

The simulation process module 220 exhaustively searches each possible state spaces and prunes redundant or unnecessary repeat loops to avoid state space explosion. Further, the simulation process module 220 checks for invariants (e.g., the online marketplace 202 balance being negative) at each step and logs the sequence of steps that led to the invariant state. These sequence of steps may represent the same sequence of steps malicious users are continuously probing in a random trial and error approach looking for potential exploits in the system.

Result analyzation process module 224 determines if a new loophole 228 is identified. If a new loophole 228 is identified, solutionization process module 230. Given that each vertex within the graph symbolizes an individual account and each edge denotes the transactional linkage between two accounts (i.e., effectively, a ledger entry), result analyzation process module 224 is equipped to expeditiously pinpoint the precise ledger entry that is problematic.

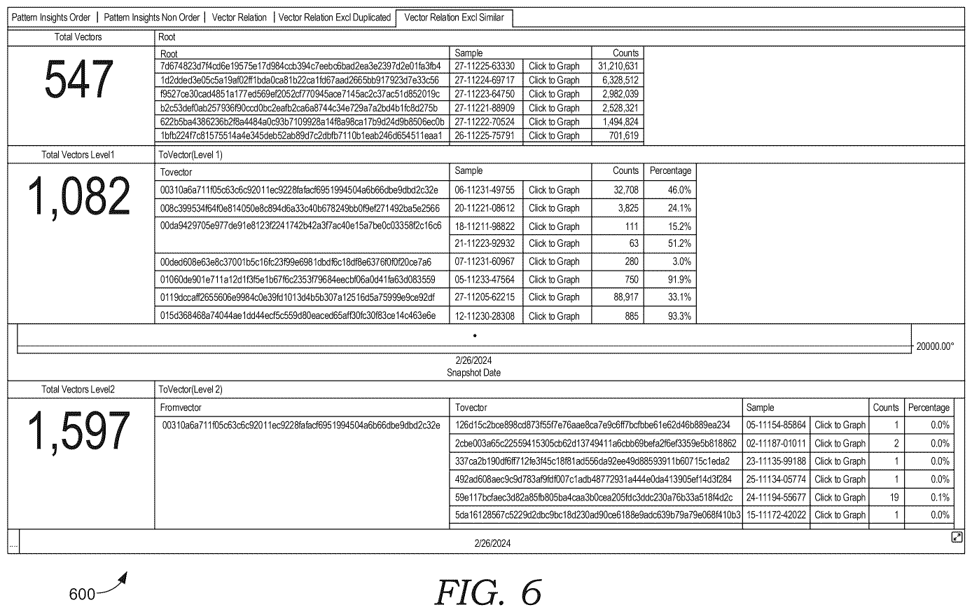

In FIG. 6, an example the transition of payment transactions from one day to another is characterized by a specific transition percentage. Referring back to FIG. 2, upon the identification of outliers via generalized detection algorithms executed by result analyzation process module 224, a thorough analysis of these anomalies can be conducted by solutionization process module 230, with a particular emphasis on discerning deviation from established historical patterns.

In some aspects, the result analyzation process module 224 includes an anomaly detection mechanism is adept at pinpointing the order that most closely resembles a given invariant, aiding in the comprehensive examination of the aberration. Solutionization process module 230 may communicate various alterations of the order to the payments protocol model 216 and the process may repeat until a solution is verified 234 and the invariant is no longer present. Accordingly, policy update/code enhancement and patching process module 236 provides the solution to online transaction platform 202 to make changes to how the transaction is executed in future transactions.

In other aspects, a manual alteration 232 may be provided to the order and communicated to the payments protocol model 216. In this scenario, the process also repeats until a solution is verified 234 and the invariant is no longer present. Accordingly, policy update/code enhancement and patching process module 236 provides the solution to online transaction platform 202 to make changes to how the transaction is executed in future transactions.

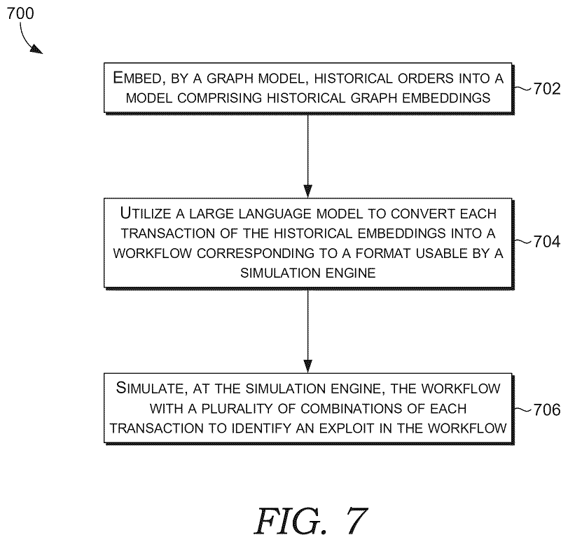

With reference now to FIG. 7, a flow diagram is provided that illustrates a method 700 for providing a self-learning apparatus to detect possible financial fraud behavior within a payment processor, in accordance with some implementations of the present disclosure. The method 700 can be performed, for instance, by the exploit remediation system 106 of FIG. 1. Each block of the method 700 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

Initially, as shown at block 702, a graph model embeds historical orders into a model comprising historical graph embeddings. At block 704, utilizing a large language model, each transaction of the historical embeddings is converted into a workflow corresponding to a format usable by a simulation engine.

At block 706, the simulation engine simulates the workflow with a plurality of combinations of each transaction to identify an exploit in the workflow. In some aspects, the simulation engine identifies the exploit in the workflow. Upon determining a fix for the exploit, the graph model comprising may update the historical graph embeddings and the fix. For example, the large language model may convert each transaction of the historical embeddings and the fix into an updated workflow corresponding to the format usable by the simulation engine.

In aspects, the simulation engine may re-simulate the updated workflow with a plurality of combinations of each transaction to determine if the exploit in the updated workflow has been eliminated. If the exploit has been eliminated, a policy update or code enhancement corresponding to the fix may be implemented.

Having described implementations of the present disclosure, an exemplary operating environment in which embodiments of the present technology can be implemented is described below in order to provide a general context for various aspects of the present disclosure. Referring initially to FIG. 8 in particular, an exemplary operating environment for implementing embodiments of the present technology is shown and designated generally as computing device 800. Computing device 800 is but one example of a suitable computing environment and is not intended to suggest any limitation as to the scope of use or functionality of the technology. Neither should the computing device 800 be interpreted as having any dependency or requirement relating to any one or combination of components illustrated.

The technology can be described in the general context of computer code or machine-usable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output (I/O) ports 818, input/output components 820, and illustrative power supply 822. Bus 810 represents what can be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 8 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 1000 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. The terms “computer storage media” and “computer storage medium”do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory can be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which can be built in. Illustrative components include a microphone, joystick, game pad, satellite dish, scanner, printer, wireless device, etc. The I/O components 820 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 800. The computing device 800 can be equipped with depth cameras, such as, stereoscopic camera systems, infrared camera systems, RGB camera systems, and combinations of these for gesture detection and recognition. Additionally, the computing device 800 can be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving. ” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. One or more computer storage media storing computer-usable instructions that, when used by one or more computing devices, cause the one or more computing devices to perform operations, the operations comprising:
embedding, by a graph model, historical orders into a model comprising historical graph embeddings;
utilizing a large language model to convert each transaction of the historical embeddings into a workflow corresponding to a format usable by a simulation engine; and
simulating, at the simulation engine, the workflow with a plurality of combinations of each transaction to identify an exploit in the workflow.

2. The media of claim 1, further comprising identifying the exploit in the workflow.

3. The media of claim 2, further comprising, upon determining a fix for the exploit, updating, by the graph model, the model comprising the historical graph embeddings and the fix.

4. The media of claim 3, further comprising, utilizing the large language model to convert each transaction of the historical embeddings and the fix into an updated workflow corresponding to the format usable by the simulation engine.

5. The media of claim 4, further comprising re-simulating, at the simulation engine, the updated workflow with a plurality of combinations of each transaction to determine if the exploit in the updated workflow has been eliminated.

6. The media of claim 5, further comprising determining the exploit in the updated workflow has been eliminated.

7. The media of claim 6, further comprising, implementing a policy update or code enhancement corresponding to the fix.

8. A computer-implemented method of utilizing self-learning to detect and eliminate possible financial fraud behavior within a payment processor:
embedding, by a graph model, historical orders into a model comprising historical graph embeddings;
utilizing a large language model to convert each transaction of the historical embeddings into a workflow corresponding to a format usable by a simulation engine; and
simulating, at the simulation engine, the workflow with a plurality of combinations of each transaction to identify an exploit in the workflow.

9. The computer-implemented method of claim 8, further comprising identifying the exploit in the workflow.

10. The computer-implemented method of claim 9, further comprising, upon determining a fix for the exploit, updating, by the graph model, the model comprising the historical graph embeddings and the fix.

11. The computer-implemented method of claim 10, further comprising, utilizing the large language model to convert each transaction of the historical embeddings and the fix into an updated workflow corresponding to the format usable by the simulation engine.

12. The computer-implemented method of claim 11, further comprising re-simulating, at the simulation engine, the updated workflow with a plurality of combinations of each transaction to determine if the exploit in the updated workflow has been eliminated.

13. The computer-implemented method of claim 12, further comprising determining the exploit in the updated workflow has been eliminated.

14. The computer-implemented method of claim 13, further comprising, implementing a policy update or code enhancement corresponding to the fix.

15. A computer system comprising:
one or more processors; and
one or more computer storage medium storing computer-usable instructions that, when used by the one or more processors, causes the computer system to perform operations comprising:
embed, by a graph model, historical orders into a model comprising historical graph embeddings;
utilize a large language model to convert each transaction of the historical embeddings into a workflow corresponding to a format usable by a simulation engine;
simulate, at the simulation engine, the workflow with a plurality of combinations of each transaction to identify an exploit in the workflow; and

16. The system of claim 15, further comprising, upon determining a fix for the exploit, updating, by the graph model, the model comprising the historical graph embeddings and the fix.

17. The system of claim 16, further comprising, utilizing the large language model to convert each transaction of the historical embeddings and the fix into an updated workflow corresponding to the format usable by the simulation engine.

18. The system of claim 17, further comprising re-simulating, at the simulation engine, the updated workflow with a plurality of combinations of each transaction to determine if the exploit in the updated workflow has been eliminated.

19. The system of claim 18, further comprising determining the exploit in the updated workflow has been eliminated.

20. The system of claim 19, further comprising, implementing a policy update or code enhancement corresponding to the fix.
